(19) United States
(12) Patent Application Publication
(10) Pub. No.: US 2024/0125066 A1
(43) Pub. Date: Apr. 18, 2024

(54) AUTONOMOUS SNOW BLOWER WITH SNOW MEASURING UNIT

(71) Applicant: Maxwell Minakov, Andover, MN (US)

(72) Inventor: Maxwell Minakov, Andover, MN (US)

(21) Appl. No.: 18/132,690

(22) Filed: Apr. 10, 2023

Related U.S. Application Data
(60) Provisional application No. 63/416,922, filed on Oct. 17, 2022.

(51) Int. Cl. E01H 5/09; G05D 1/02

(52) U.S. Cl. CPC E01H 5/092; G05D 1/0214; G05D 1/0278

(57) ABSTRACT

An autonomous snow removal system is described. The autonomous snow removal system includes an autonomous, battery-powered, robot with an interchangeable snow removal assembly. The robot includes an onboard computer which connects wirelessly to a snow removal unit. As snow falls into the unit, the snow is measured and categorized, and data is transmitted to the onboard computer. The system may determine when to clear snow based at least in part on the amount and type of snow that has been collected. An object of the autonomous snow removal system is to provide highly accurate snow removal operations autonomously. Users may also calibrate the system and set way points using the app such that the robot clears snow from driveways or walkways only when specific conditions are present as preset by the user.

### CROSS-REFERENCE TO RELATED APPLICATIONS

The present application claims the benefit of U.S. Provisional Application No. 63/416,922, filed on Oct. 17, 2022, the disclosure of which is incorporated by reference herein in its entirety.

### FIELD OF THE INVENTION

The present invention relates to snow removal. More specifically, the present invention relates to an intelligent system for monitoring and removing snow autonomously.

### BACKGROUND

A snow blower or snow thrower is a machine for removing snow from driveways, sidewalks, roadways, railroad tracks, ice rinks, and runways. Snow blowers typically use an auger or impeller to move snow. Traditionally, snow blowers use a gasoline or diesel engine to throw snow to another location or into a truck to be hauled away. This is in contrast with the action of snowplows, which push snow to the front or side. Snow blowers typically discharge snow to one side. Snow blowers range from the very small, capable of removing only a few inches of light snow in an 18 to 20 in path, to the very large, which are mounted onto heavy-duty winter service vehicles and capable of moving 20-foot wide, or wider, swaths of heavy snow up to six feet deep. Snow blowers can generally be divided into two classes: single-stage and two-stage. On a single-stage snow blower, the auger (the paddle mechanism visible from the front) pulls snow into the machine and directs it out of a discharge chute. The auger contacts the ground, making single-stage snow blowers unsuitable for use on unpaved surfaces. On a two-stage snow blower, the auger pulls snow into the machine and feeds it into a high-speed impeller, which in turn directs it out of a discharge chute. Two-stage snow blowers can generally handle deeper snow depths than single-stage ones, and because their augers don't touch the ground, they can be used on unpaved surfaces. Snow blowers are typically bulky, heavy, and difficult to maneuver. Further, as snow blowers generally need to be advanced slowly when in use, it can be very time consuming to clear areas of snow.

### SUMMARY OF THE INVENTION

In a first aspect, the invention pertains to an autonomous snow removal system including an autonomous robot with a snow removal assembly and a snow measuring unit (SMU). A feature of the invention is to perform autonomous snow clearing operations. For example, a user sets up the robot along a driveway. When the snow arrives, the system triggers a snow clearing event and the robot clears the driveway before said user arrives home from work.

In another aspect, a robot for autonomous removal of snow includes a controller, a pair of axially aligned drive wheels, a body, a brush assembly, a plurality of sensors, and a snow measuring unit. The controller includes a microprocess, a receiver, a transmitter, and a memory. The includes a housing extending between the drive wheels. The housing has a base plate and a cover. The controller, a power supply, and a wheel drive motor are contained within a housing cavity. The wheel drive motor is connected to the controller. The brush assembly includes a brush configured to rotate about a central axis, a brush drive motor operatively connected to the controller, a framework, and a shroud. The brush assembly is connected to a forward facing portion of the robot body. A plurality of sensors are disposed about the body and/or the brush assembly. The sensors are in communication with the controller. A snow measuring unit transmits a plurality of collected snow characteristics to the controller. The controller uses the snow characteristics to determine a schedule for removing snow from a pre-defined area. In some embodiments, the plurality of snow characteristics includes a snow volume and a snow weight.

In some embodiments, the snow measuring unit includes a scale mounted to a bottom plate, a rearward wall, a left sidewall, a right sidewall, and a front wall surrounding the bottom plate. The rearward wall, the left and right sidewalls, and the front wall defines a snow collection cavity. The scale is configured to measure a weight of collected snow within the snow collection cavity. In some embodiments, the front wall includes a pivoting door, the left sidewall comprises a left sliding panel, and the right sidewall comprises a right sliding panel. The bottom plate and left and right sliding panels are configured to slide through the pivoting door, such that the collected snow is discarded outside the snow collection cavity. In some embodiments, the snow measuring unit includes a sensor configured to measure a height of the snow. In some embodiments, the snow measuring unit determines a volume of the snow from a width and a length of the snow collection cavity and the height of the collected snow.

In some embodiments, a boundary wire connected to the snow removal unit defines a snow removal area. In some embodiments, the controller includes a GPS. The GPS may be configured to generate a geofence defining a snow removal area. In some embodiments, the robot is configured to avoid obstacles in a predetermined snow removal path. In some embodiments, when the robot fails to avoid an obstacle, the robot sends an alert to a user and the robot is controllable from an app running on a handheld computing device.

In another aspect, the invention pertains to a robot for autonomous removal of snow including a pair of track wheels and a chassis mounted therebetween, and an interchangeable snow removal assembly mounted to a forward portion of the chassis. The chassis includes a controller, a rechargeable battery, and a first drive assembly in communication with the controller and operably coupled to the pair of track wheels. An interchangeable snow removal assembly is mounted to a forward portion of the chassis. The interchangeable snow removal assembly includes a second drive assembly in communication with the controller.

In some embodiments, the first drive assembly is configured to drive each of the pair of track wheels independently. In some embodiments, the interchangeable snow removal assembly attaches to the chassis at a first fixed mounting point and a second adjustable mounting point. In some embodiments, the second adjustable mounting point includes a cable and a tensioning device. The tensioning device is configured to adjust a length of the cable.

In some embodiments, the interchangeable snow removal assembly includes a brush with a brush shaft configured to rotate about a central axis, a brush drive motor operatively connected to the controller, a framework, and a shroud. In some embodiments, the brush drive motor is mounted above the shroud. In some embodiments, the brush drive motor is configured to rotate a drive shaft, where the drive shaft is connected to the brush shaft with a differential gear.

In a further aspect, the invention pertains to a method for autonomous snow removal including the steps of providing a robot for autonomous removal of snow; installing s snow removal unit in proximity to an area to be cleared of snow; determining a snow removal plan; and executing the snow removal plan. In some embodiments, the method further includes the steps of collecting snow in the snow removal unit; measuring characteristics of the collected snow; and transmitting the measured characteristics to the controller. In some embodiments, the measured characteristics include a weight and a volume. In some embodiments, the area to be cleared of snow is defined by a boundary wire. In some embodiments, the area to be cleared of snow is a geofenced area.

A feature and advantage of the autonomous snow removal system is to provide a safe and reliable boundary for operation of the robot. The system may include a boundary wire for establishing the maximum travel distanced for the robot and may be installed underground by the user around their driveway. When the robot detects it is near the underground wire or any boundary beacons it will halt operations. Another embodiment can include boundary beacons that are placed on driveway corners and possibly on the sides of a driveway. These beacons transmit data to the robot regarding its relative position and its exact location relative to a driveway.

Another feature of the autonomous snow removal system is providing an interface to allow users to monitor all robot activities using an application (app) on a computing device by connecting with the robot's wireless transmitter/receiver. The app may connect with the robot via Bluetooth or over Wi-Fi routers so information (such as movements, onboard digital video, and the like) can be viewed in real time. The robot also includes with an onboard digital compass and global positioning system (GPS) that sends its heading and location to the app at specified intervals. Users may also trigger a snow removal event manually or control the robot using the app. All interactions with the app may be used to train an AI for improved autonomous operations. The GPS may also include real time kinematics (RTK) capabilities.

Another feature of the autonomous snow removal system is providing a separate snow measuring unit (SMU) that is installed in the vicinity of a driveway or walkway that collects snow data and sends it wirelessly to the robot. For example, a user may know that their property often builds snow drifts that are greater than the local forecasts. The SMU catches snow inside a central cavity and performs various metrics such as gravimetric weighing, moisture content, temperature and humidity etc. and delivers it to the robot. The robot algorithms factor these variables into an equation that allows it to perform the necessary snow removal events successfully. Snow measurements allow the robot to keep the brush snow removal method active only when required and helps the robot decide how often it should go out to clean because it adapts to different types of snow—light or heavy (instead of going out during every inch of snow that falls).

Another feature of the autonomous snow removal system is providing a collision avoidance system. Onboard lights and cameras observe the surroundings and will halt the robot within a preset distance. The robot may also include onboard LEDs that flash during operation to warn pedestrians that may be in the area. If an object is detected in the robot's path, the robot will halt and an alarm will sound. Should an artifact get caught in the robot that was not detected by the cameras, onboard load sensors may also halt the machine to minimize damage. During any of these events, the robot will send a notification to the app that alerts the user to the issue so they can take action. In addition, snow drifts can be detected via onboard, 3D lidar scanners, camera vision in combination with reflectors on the edges of the driveway in another embodiment of the invention. In addition, the 3D lidar and camera for drift detection can also be mounted a on a pole somewhere on the side of the driveway or even outside of the driveway.

Another feature and advantage of the autonomous snow removal system invention is to provide modularity. The snow collection method at the front can be comprised of either metal blade sets or sweeping bristle sets. In some embodiments, the snow removal system may include vaccums or blowers. Once a snow type is detected, the robot can alert the user to exchange the snow removal system to accommodate light or heavy snow (for example, blades for heavy snow and bristles for light snow) herein referred to as the interchangeable snow removal system.

Another feature of the autonomous snow removal system is to allow for customized snow removal periods. Within the light or heavy snow classifications, users can determine how often the robot will perform a snow removal event. For example, using the app, a homeowner may preset the robot to perform a snow removal event whenever the SMU collects 0.75 inches of snow.

Another feature of the autonomous snow removal system is to provide quiet, continuous power to the robot. In some embodiments, the robot may include onboard, rechargeable, lithium-ion batteries. Other embodiments may have either a manual or self-charging elements and be protected in a self-charging station. Embodiments of this self-charging station can include walls and a roof to protect it from the elements. Said batteries (as well as other sensitive components therein) may be wrapped in reflective insulation bubble wrap or another form of insulation along with a constant-heating module to keep the battery and electronics and motors warm.

### BRIEF DESCRIPTION OF THE FIGURES

Embodiments of the invention will be described with respect to the figures, in which like reference numerals denote like elements, and in which:

FIG. 1A depicts a perspective top view of a robot with a snow removal assembly, according to one or more embodiments of the disclosure.

FIG. 1B depicts a bottom view of the robot of FIG. 1A.

FIG. 1C depicts a top view of the robot of FIG. 1A with a robot body cover removed and a frame and shroud of the snow removal assembly removed.

FIG. 1D depicts a perspective top view of the robot body of FIG. 1C with a tread and tread cover removed.

FIG. 2A depicts a perspective top view of a robot with a snow removal assembly, according to one or more embodiments of the disclosure.

FIG. 2B depicts an enlarged cut away view of the snow removal removal assembly of FIG. 2A depicting a differential.

FIG. 3 depicts a perspective view of a robot docking station, according to one or more embodiments of the disclosure.

FIG. 4 depicts a is a diagrammatic view of a robot control system, according to one or more embodiments of the disclosure.

FIG. 5A depicts a top perspective view of a snow collection unit in a collection mode, according to one or more embodiments of the disclosure.

FIG. 5B depicts a perspective top view of the snow collection unit of FIG. 5A in an empty mode, according to one or more embodiments of the disclosure.

FIG. 6 depicts a diagrammatic view of a snow collection unit control system, according to one or more embodiments of the disclosure.

FIG. 7 depicts a method of removing snow, according to one or more embodiments of the disclosure.

FIG. 8 depicts a snow removal route followed by a robot clearing a driveway, according to one or more embodiments of the disclosure.

FIG. 9 depicts a high-level view of a snow removal system for clearing of snow by an autonomous robot, according to one or more embodiments of the disclosure.

FIG. 10A depicts an interface for a snow removal system displayed on a handheld computing device, according to one or more embodiments of the disclosure.

FIG. 10B depicts an interface for a snow removal system displayed on a handheld computing device, according to one or more embodiments of the disclosure.

While the embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

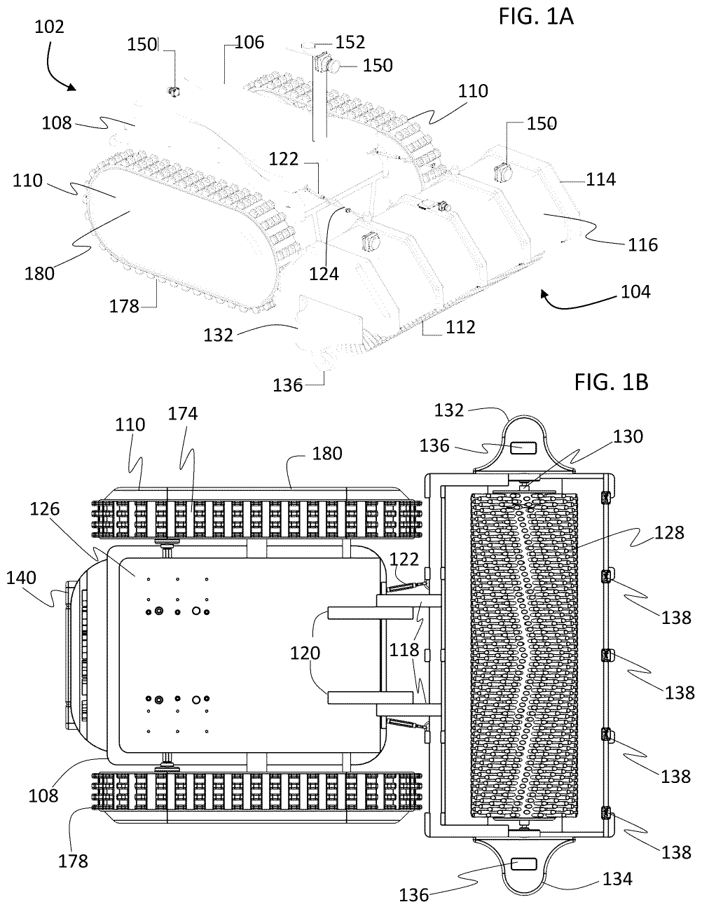

Referring to FIG. 1, a robot 102 is depicted with an interchangeable snow removal assembly 104. The robot 102 has a generally rectangular shaped body 106 with a cover 108, a pair of track wheels 110, and an interchangeable snow removal assembly 104 attached to a forward portion of the robot 102. In one or more embodiments, the snow removal assembly 104 may include a brush assembly 112, which is described in more detail below. The snow removal assembly 104 may include a framework 114 and a shroud 116 covering a top portion of the brush assembly 104. In one or more embodiments, the snow removal assembly 104 may attach to the robot body 106 at multiple points. At a first, lower attachment point, the snow removal assembly framework 114 may have one or more tubular projections 118 that correspond to tubular projections 120 from robot body 106. In some embodiments, tubular projections 120 may be permanently affixed to a base plate 126 of the robot 106. For example, tubular projections 120 may be welded to base plate 126. In some embodiments, tubular projections 120 may be removably fastened to base plate 126 using screws, nuts, bolts, or the like. In some embodiments, one set of tubular projections may be slightly wider or have a slightly larger diameter and an opening at one end so as to slide over the corresponding projection for a rigid connection. As depicted in FIG. 1B, tubular projections 118, 120 may align so that they can be fastened to one another. In some embodiments, tubular projections 118, 120 may be rigidly fastened using a plurality of nuts, bolts, screws, or the like. In some embodiments, tubular projections 118, 120 may be pivotally fastened, such as using a single bolt as a pivot point. At a second, upper attachment point, an adjustable connection may be used to secure a top portion of the framework 114 to the robot body 106. For example, an adjustable connection may comprise a turnbuckle 122 and rope 124. The adjustable connection may allow for altering a height of the interchangeable snow removal assembly 104. In some embodiments, motors within the robot body 106 may allow for automatically adjusting the height by rotating the turnbuckles to lengthen or shorten the adjustable connection.

The brush assembly 112 may include a brush or bristle impeller 128 mounted about a brush shaft 130. In some embodiments, the brush 128 may be multiple brushes mounted on a common shaft. In some embodiments, the brush may be multiple brushes mounted on multiple shafts, which may rotate in unison or independently. Although framework 114 and shroud 116 are shown covering a top half of the brush 128, it is not necessary that half of the brush is covered. In some embodiments, enough of the brush is covered so that as the brush is rotated, snow is directed away from the robot and is not allowed to fling backwards over the top of the brush assembly or robot. In some embodiments, more or less than half of the brush may be covered by the shroud. In some embodiments, between 20 and 60% of the brush is covered by the shroud. In some embodiments, about one quarter of the brush is covered by the shroud. In the embodiments shown in FIG. 1, brush motor housings 132, 134 are shown mounted at each end of the brush assembly 112. In some embodiments, brush motor housings 132, 134 may further include caster wheels 136. Caster wheels 136 may freely spin and rotate to offer additional support to the brush assembly 112. In some embodiments, caster wheels 136 may be adjustable and powered, offering an alternative for automatically adjusting a height of the brush assembly 112. In some embodiments, caster wheels 136 may include sensors for detecting a height of the brush assembly 112. As snow drifts or is otherwise moved, it may be necessary to continuously detect and adjust a height of the snow assembly during operation. Other sensors 138, 140 may be mounted around the framework 114 or robot body 106. Sensors 138, 140 may include, but are not limited to, proximity sensors, height sensors, thermal sensors, humidity sensors, temperature sensors, or the like. Sensors 138, 140 may be ultrasonic, infrared, or any encompass other known technologies commonly used in robotics such as radar, lidar, or the like. Referring to FIG. 1C, the brush assembly is shown with the framework 114, shroud 116, and motor housings 132, 134 removed. Brush drive motors 142, 144 are shown affixed to either end of brush shaft 130 to rotate the brush 128 for clearing snow. In some embodiments, the interchangeable snow removal assembly may include an articulating shovel underneath the bristles and blades that can be extended to remove heavy snow piles such as those encountered after a snow plow truck deposits fugitive ice and snow into a cleared drive or walkway. In some embodiments, the interchangeable snow removal assembly may include a salt delivery mechanism that spreads granular salt from the rear of the rear of the robot after snow removal has taken place. In some embodiments, the interchangeable snow removal assembly may include a mechanism to dispense liquids such as a liquid deicing agent or melting solution. In some embodiments, the interchangeable snow removal assembly may include an auger or metal impellers. In some embodiments, the interchangeable snow removal assembly may include a chute for directing expelled snow. In some embodiments, the interchangeable snow removal assembly may include a plow. In some embodiments, the interchangeable snow removal assembly may include a blower.

The robot 102 may additionally include additional LED or other lights or sensors about its body 106 or cover 108. Lighting may be used for various purposes. In some embodiments, lighting may be used for safety by improving visibility of the robot for users or others in the vicinity to readily see and identify the robot. For example, a rotating light atop the robot body allows the robot to be easily spotted. Lighting may also be used to allow robot cameras to better able to view surroundings including obstacles and the like. In some embodiments, the robot 102 may include a plurality of forward, rearward, or sideward facing cameras 150. Cameras may include, for example, still images, digital video, thermal imaging or the like. In some embodiments, robot 102 may include a compass 152. The compass 152 may be elevated or strategically located to avoid interference from metal or electrical components of the robot 102. Other sensors may include, but are not limited to, collision avoidance system electrified boundary wire sensors, GPS units, accelerometers, visual and audio alarms. All sensors, compasses, cameras, or the like are in communication with a microprocessor as explained in further detail below.

FIG. 1C depicts a top view of robot 102 with the cover removed, showing some elements mounted to a base plate 126 and housed with a cavity defined by the cover. In some embodiments, robot 102 may be wired to a power source, such as by an extension cord. In some embodiments, robot 102 includes a battery 154. In some embodiments, battery 154 may be rechargeable, such as a rechargeable lithium-ion battery. Battery 154 may include multiple battery modules or multiple cells for extending running times. A controller unit 156 and associated electronics may be mounted within robot 102 and are explained in further detail below.

Referring to FIG. 1D, a perspective view of a robot is shown with the battery, one wheel cover, and one tread removed for a better view of the track wheel and drive assemblies. Each track wheel 110 has a rear sprocket 160 and a forward sprocket 162 coupled with the robot body. In some embodiments, rear sprocket 160 is connected to a motor shaft 164 of a drive assembly 168. In some embodiments, forward sprocket 164 is connected to a front axle 170 that is secured to the robot body with one or more sleeve bearings 172. Each of the pair of track wheels has a separate motor shaft and drive assembly such that each of the rear sprockets are independently controlled. For example, rotating one of the rear sprockets in a clockwise direction and the other rear sprocket in a counter-clockwise direction may cause the robot to rotate and change its orientation. In some embodiments, the forward sprockets may have an independent drive assembly which could provide additional power for maneuvering through heavy snow, steep hills, or other difficult terrain. A polymer belt 174 surrounds the forward and reward sprockets 160, 162. The belt 174 has teeth 176 on an interior surface configured to interface with the sprockets 160, 162. In some embodiments, the belt 174 has treads 178 on an outer surface. In some embodiments, the outer surface of belt 174 may include additional features such as chains, studs, or the like to improve traction on slippery surfaces such as snow or ice. While two sprockets are shown and described, track wheels having 3, 4, or more sprockets are not beyond the scope of this disclosure. Track wheels may take on a variety of shapes depending on the sprocket configuration including, but not limited to, oval or triangular shapes. A wheel cover 180 may be secured to the track wheel or robot, such as by a receiver 182 which cooperates with a dowel 184 affixed to the robot body. The cover 180 may protect the sprockets 160, 162 or other components from being impacted by snow or ice that might lodge in place preventing the sprockets 160, 162 from rotating or causing other damage. The pair of track wheels 110 may include sensors such as load sensors that allow their speed and power to be adjusted. For example, if the robot 102 gets stuck on a snow patch, the track wheels 110 can be fed more amperage by the microcontroller to overcome the obstacle. Other embodiments such as conventional round wheels are not beyond the scope of this disclosure.

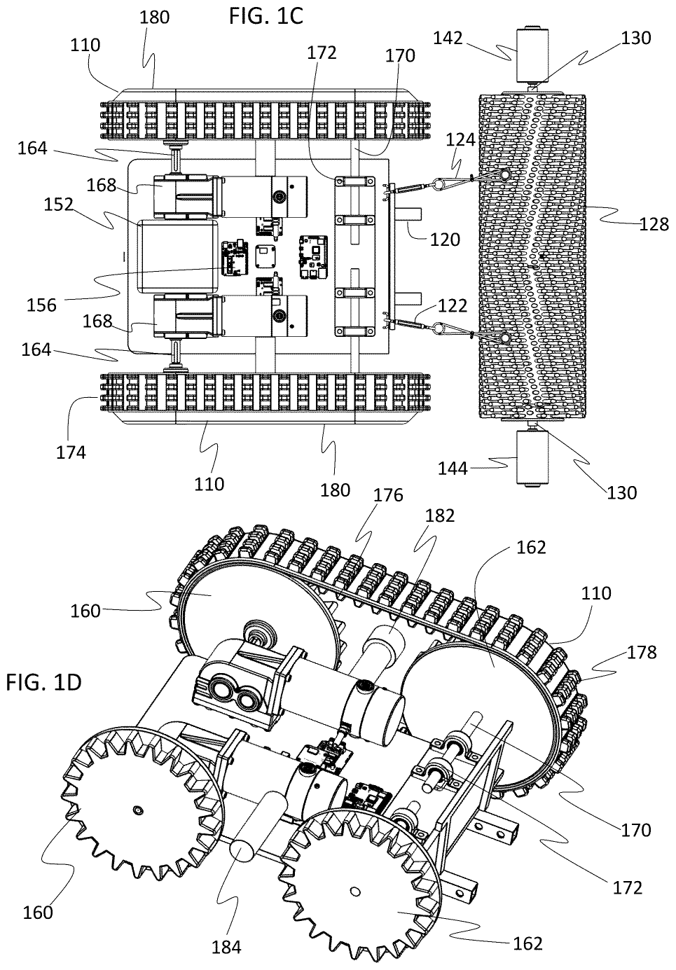

Referring to FIGS. 2A and 2B, a robot 102 is shown with an alternative embodiment of brush assembly 204. Brush assembly 204 has a first brush 206 mounted on a first brush shaft 208 and a second brush 210 mounted on a second brush shaft 212. A brush motor (not shown) is mounted on in a brush motor housing 214 on the framework 216 and/or shroud 218 above the brushes 204, 206. The brush motor rotates a drive draft 220. Drive shaft 220 joins brush shafts 206, 208 at a gear box 222, such as a differential, to translate the rotational force of the brush motor and rotate the brushes. Additional brushes and/or motors are not beyond the scope of this disclosure. For example, in some embodiments, the brush assembly may have one motor for each brush. In some embodiments, the snow assembly may have 4 brushes and 2 motors, with each motor powering a pair of brushes. Brush motor housing 214 may further include additional batteries or battery packs. Having independent batteries for the brush motor improves power output to the brush motor. This further improves battery efficiency for the robot.

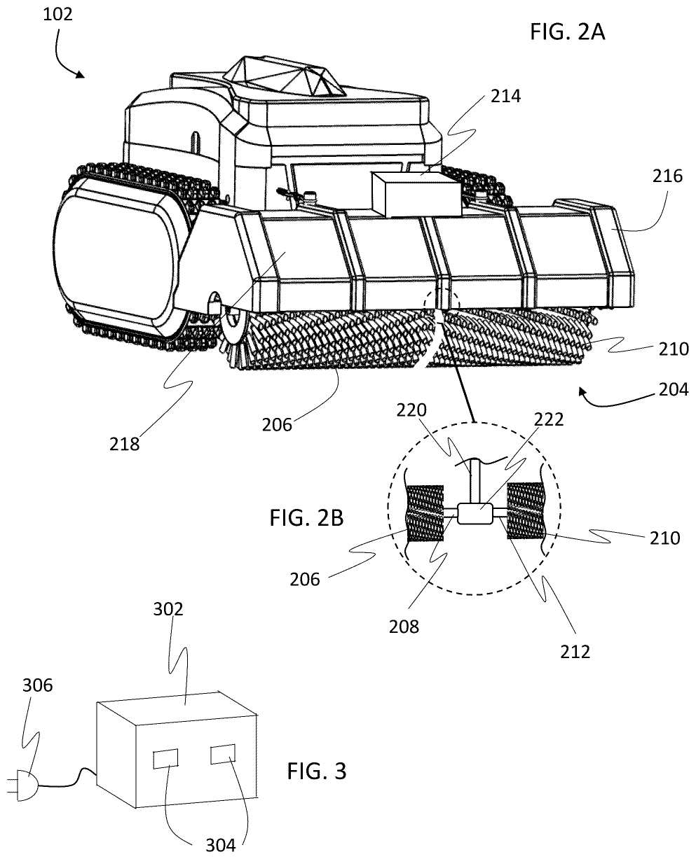

FIG. 3 depicts a charging or docking station 302 according to embodiments of the disclosure. A docking station may be used to recharge the battery located in the robot housing. The docking station may include a plug 306 for access to a continuous source of electricity such as a wall outlet. In some embodiments, the docking station may be hardwired directly to a power source or electrical system. In some embodiments, docking station 302 includes one or more electrical contacts 304 that interface with corresponding contacts on the robot for transferring voltage and charging the battery. In some embodiments, the docking station and robot may have suitable hardware for enabling wireless charging. The docking station may include similar electronics to those found on the robot and discussed in detail below including, but not limited to, a microprocessor, a memory, a wireless transceiver, an antenna, and various sensors. Sensors may be used to detect and provide guidance to the robot, so that the robot may automatically correct course and align properly with electrical contacts 304 for recharging the robot battery. In some embodiments, the docking station 302 may be located indoors such inside a garage. Robot 102 may be in communication with an automatic garage door opener allowing the robot to enter the garage for charging and exit the garage when executing a routine to clear snow. In some embodiments, docking station 302 may be located outdoors. In some embodiments, docking station 302 may include a roof and/or walls or other protective structures to shield the unit from snow and the elements.

The elements, particularly low temperatures, may have an impact on electronics, batteries, motors, and the like comprising the snow removal system such as the components of the robot, docking station, or snow measuring unit discussed below. Various techniques may be employed to conserve heat or otherwise protect these components. For example, insulation may be inserted into housings or wrapped around individual components. Examples of such insulation include, but are not limited to, reflective insulation bubble wrap, foam, or the like. In some embodiments, heaters, heating elements, heating modules or the like may be strategically placed to warm batteries and/or motors.

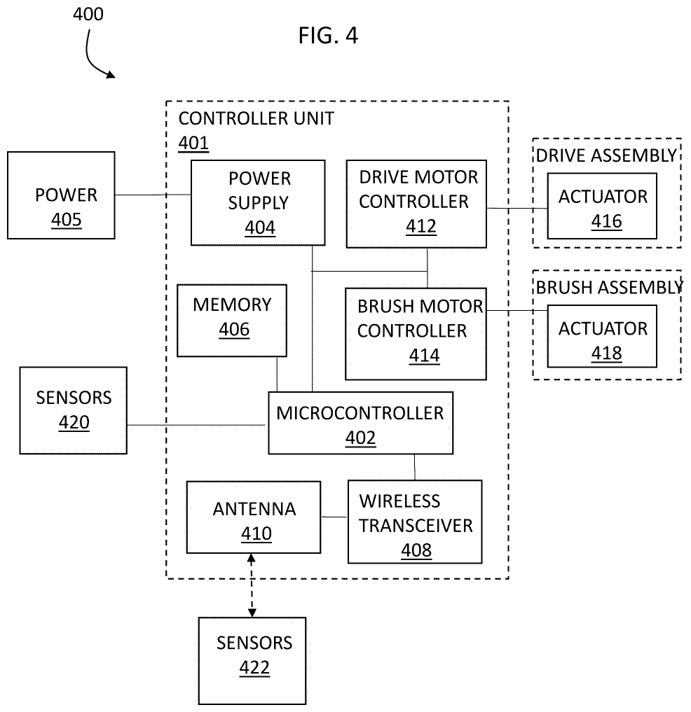

Referring to FIG. 4, a diagrammatic view of a robot control system 400 is shown. Some or all of these components may be located in the robot 102, in the docking station 302, or in the snow collection unit as discussed in further detail below. Some components, or variations thereof, may be located in multiple locations. For example, the robot 102, docking station 302, and snow collection unit may all include a microcontroller, memory, transceiver, in addition to other elements. The robot control system 400 includes a controller unit 401 comprising a microprocessor or microcontroller 402 connected to a power supply 404, a memory 406, and a wireless transceiver 408. Wireless transceiver 408 may be further connected with an antenna 410. A power source 405 is electrically connected to the power supply 404. The power supply 404 and CPU 402 are further connected to the drive motor controller 412 and brush motor controller 414. In some embodiments, the brush motor controller may be replaced for the controller of a device corresponding to the attached snow removal assembly. For example, the controller may be an auger controller or a blower controller. Drive motor controller 412 is further connected to an actuator 416 as part of a drive assembly to power the wheels. Brush motor controller 414 is further connected to an actuator 418 in the brush assembly to rotate the brush. In some embodiments, sensors 420 are electrically connected to the microcontroller 402. In some embodiments, sensors 422 are wirelessly connected to the microcontroller 402.

All elements of the robot control system 400 are in communication with one another whether through direct electrical communication or using wireless technologies. Examples of wireless communications include, but are not limited to, Wi-Fi, Bluetooth, Zigbee, Z-Wave, RF, infrared, or the like. In some embodiments, processing may be shared among devices. For example, performing computational tasks on a microcontroller 402 in the docking station 302 may be preferable to performing computational tasks on a microcontroller 402 in the robot 102. It may extend the robot battery life to perform CPU intensive tasks on a controller attached to a permanent power source and then wirelessly transmit instructions instead of performing those computations on a processor powered by the battery. Examples of sensors include, but are not limited to, lights (LED etc.); boundary sensors; onboard cameras (still, digital video, thermal imaging etc.); sensors (temperature, humidity, ultrasonic distance sensor, etc.); collision avoidance system electrified boundary wire sensor (GPS unit; accelerometers; visual and audio alarms, boundary wire sensor, and an onboard computer. The aforementioned GPS unit also connects to a geofencing routine that alerts the user if the robot, snow collection unit, or other components leaves the property to prevent theft. During instances when the robot becomes lost, the GPS and RTK system will automatically guide it back to its charging station. In some embodiments, the geofencing routine may be used to set a boundary in lieu of placing a physical boundary wire. In some embodiments, the robot may include a proprietary addon device known as a ‘carbon origin’ retrofit that aids in establishing autonomous operations that rely on machine learning and artificial intelligence technology.

A further aspect of an autonomous snow removal system is a snow measuring unit that determines snow characteristics. Such characteristics include, but are not limited to, snow levels and snow type. A snow level might be, for example, a height of a snowfall or a volume of a snow fall. Snow types might include, for example, a moisture content, or a weight, or the like. Determination of snow characteristics improves the efficiency of the snow removal system, particularly with respect to route planning and power management. For example, a light fluffy snow (having a low moisture content) may require less power to clear than a heavy dense snow (having a higher moisture content). Accordingly, by way of example, a robot may be wait and charge its battery until 2 inches of light fluffy snow has accumulated as opposed to needing to the clear heavy dense snow at 0.5 inches of accumulation.

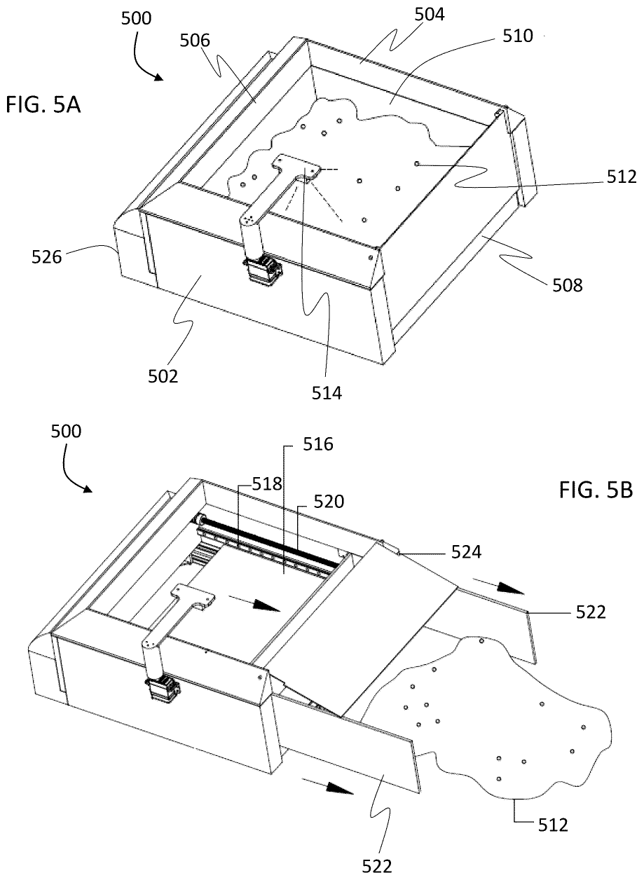

Referring to FIG. 5, a snow measuring unit 500 includes opposing left and right sidewalls 502, 504, a rearward wall 506 and a forward wall 508 which define a central cavity 510 where snow 512 is collected. One or more sensors 514 mounted the snow measuring unit 500, or otherwise integrated throughout the walls or other components, can measure snow characteristics. Such sensors may include, but are not limited to, infrared sensors for measuring height or distance, moisture sensors for determining a moisture content of the snow, ultrasonic sensors for determining a snow density, thermal sensors for detecting a snow temperature, and other sensors known to those skilled in the art. In some embodiments, the snow measuring unit includes a platform with scale 516 as shown in FIG. 5B. The platform 516 slides along metal rails 518 by means of at least two linear lead screws 520 configured parallel to one another. The snow measuring unit may further include interior sidewalls 522 configured to slide along with platform 516. A leading edge of the interior sidewalls 522 raises a pivoting door 524 allowing the collected snow 512 to exit the unit. As the interior sidewalls 522 recede back into the unit, pivoting door 524 lowers and scrapes the collected snow 512 from the platform 516. By emptying the collected snow at timed intervals, the snow collection unit may measure a rate of snowfall, and, further, detect changes in rates of snowfall during storms. The rates of snowfall may then be used by the system to adjust the snow removal schedule for optimal performance or to meet predefined user preferences. The snow removal unit 500 may further include a housing 526 to retain electrical and mechanical components such as a controller unit and motors to drive the screws 520. In some embodiments, the snow collection unit may include a battery such as a rechargeable battery. In some embodiments, the snow collection unit may include a plug or be hardwired to a power source. In some embodiments, the snow collection unit 500 may include or be otherwise incorporated with a docking station 302. In some embodiments, a conventional, electrified boundary wire may be connected to the controller unit of the snow collection unit. The snow collection unit 500 may be generally formed of a rigid material including but not limited to metal, plastic and the like.

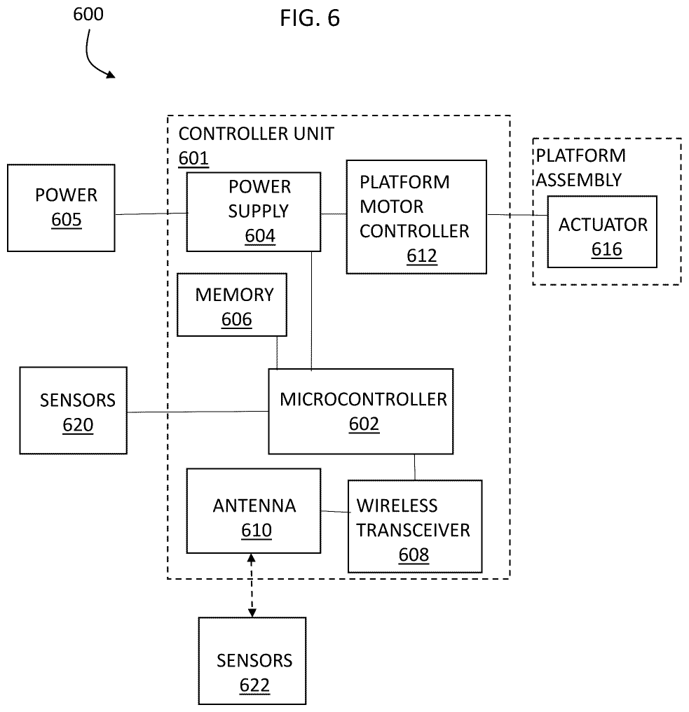

Referring to FIG. 6, a diagrammatic view of a snow measuring control system 600 is shown. The snow measuring control system 600 includes a controller unit 601 comprising a microprocessor or microcontroller 602 connected to a power supply 604, a memory 606, and a wireless transceiver 608. Wireless transceiver 608 may be further connected with an antenna 610. A power source 605 is electrically connected to the power supply 604. In some embodiments, power source 605 is a battery such as a rechargeable battery. In some embodiments, power source 605 is a direct wired connection or plug. The power supply 604 and CPU 602 are further connected to the platform motor controller 612. The platform motor controller 612 is further connected to an actuator 616 as part of a platform assembly to rotate the screw which causes the platform and interior sidewalls to either extend outwardly from the unit or retract inwardly into the unit. In some embodiments, sensors 620 are electrically connected to the microcontroller 402. In some embodiments, sensors 622 are wirelessly connected to the microcontroller 602. As discussed above, all elements of the snow measuring unit control system are in communication with the robot control system and, in some embodiments, with the docking station. In some embodiments, processing may be shared among devices. For example, if the snow measuring unit is operating on battery power, performing computational tasks on a microcontroller in the docking station may be preferable to performing computational tasks on a microcontroller in the robot snow measuring unit. It may extend the snow measuring unit battery life to perform CPU intensive tasks on a controller attached to a permanent power source and wirelessly transmit data such as snow characteristics instead of performing those computations on a processor powered by the battery.

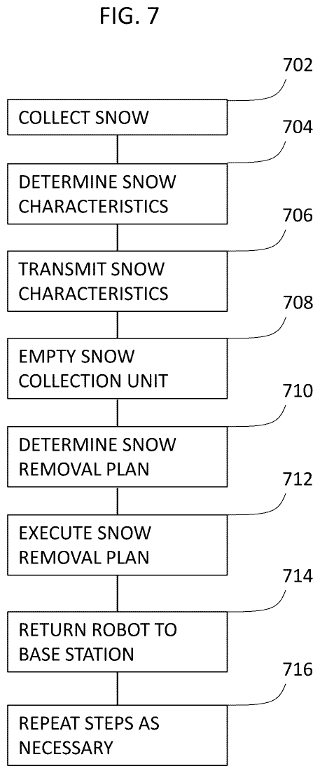

FIG. 7 depicts a method of operating a snow removal system according to embodiments of the disclosure. In step 702 the snow measuring unit is used to collect snow and determine snow characteristics 704. The snow characteristics are transmitted 706 to the snow removal system. The snow collection unit empties the central cavity of snow so that fresh measurements may be taken 708. The snow removal system determines a snow removal plan 710 based upon the snow characteristics. Such a plan might include, for example, how often to send out the robot, what path the robot should take to clear an area, and how much power to impart to the snow removal assembly. The robot executes the snow removal plan 712 and returns to the base station for recharging 714. Any of the above steps may be repeated as necessary to clear an area of snow 716. Additional tasks may be executed by the system at various times during operation. For example, each time the robot turns, the compass bearing is verified to ensure the robot properly executed the maneuver. At times, the treads may slip or slide on ice, snow, or other slick surfaces. Accordingly, the controller may believe, for example, that the robot executed a 90 degree turn when the robot turned only 70 degrees because of a slipping tread. When the robot verifies a heading with the compass, the controller may compensate and perform additional turns as necessary. The robot also continuously checks its surrounds for obstacles. In some embodiments, the robot may attempt to automatically route around obstacles. In some embodiments, the robot may notify a user that manual intervention is required to maneuver around obstacles. In some embodiments, the robot may determine it is stuck and cease further movement while awaiting manual intervention. In some embodiments, manual intervention may be manual remote controls through an app, as discussed below, or through remote controls on a handheld device such as a joystick or similar controller. In some embodiments, manual intervention may require physically relocating the robot by picking it up and repositing it or carrying it to a new location before it continues executing the snow removal plan. In some embodiments, the snow removal plan may be updated once the robot encounters an obstacle so that the robot may then continue to avoid the obstacle.

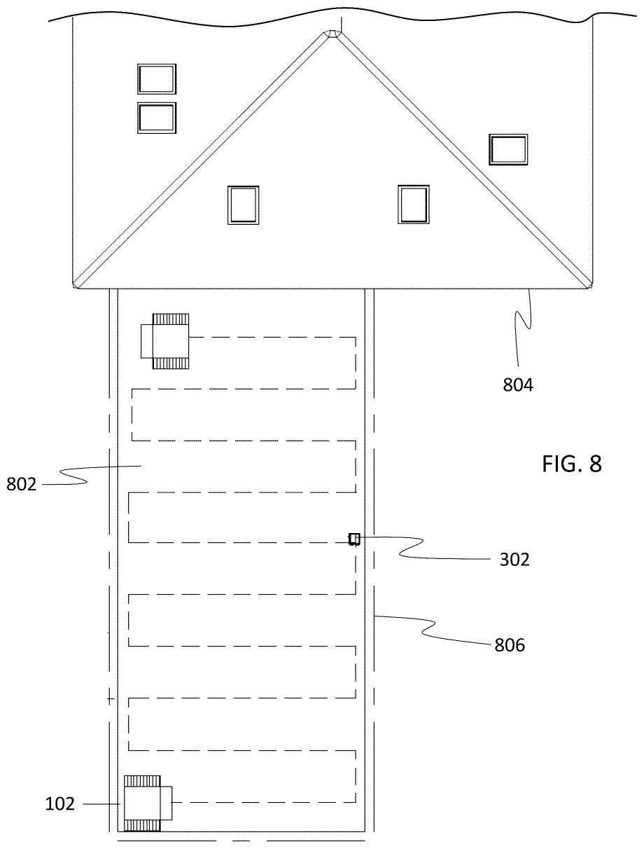

FIG. 8 depicts a top view of a robot 102 and snow measuring unit 302 in operation on a driveway 802 in front of a house 804. In some embodiments, a boundary wire 806 may be installed along a perimeter of the driveway 802. The boundary wire 806 may be in direct physical communication with the snow measuring unit 302. The snow measuring unit 302, in turn, may be in wireless communication with controllers in the robot 102, docking station, and other computer or cloud servers as discussed in more detail below. The dashed line 806 represents a potential path for robot 102 to take to clear snow from the driveway 802. As show, the robot starts in a position near the end of the driveway and makes passes back and forth, generally about the width of the robot, until it has cleared the entire driveway and ends up in a final position near the house 804.

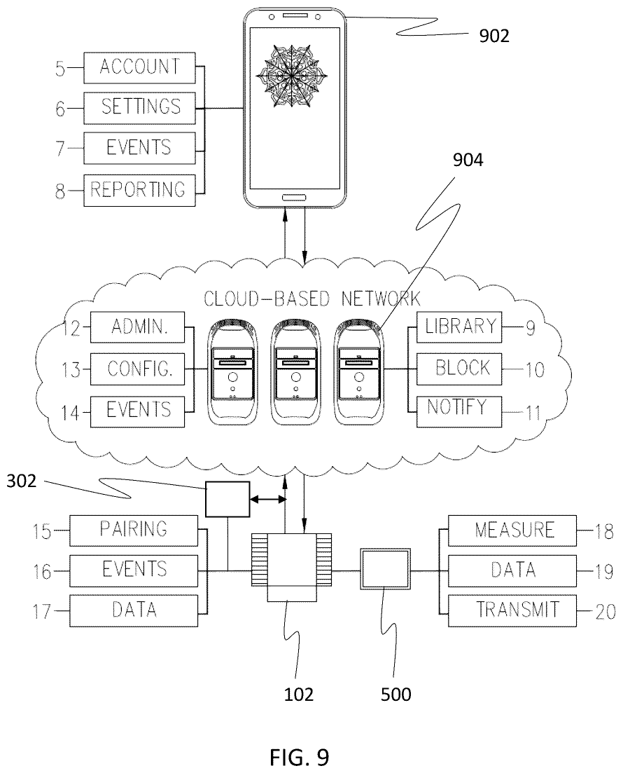

FIG. 9 shows a high-level view of a snow removal system. An app may run on a computing device 902 and may have operations that include but are not limited to storing member accounts 5 (subscription and payments etc.); settings 6 (snow measuring unit selections and pairing, boundary operations, and calibrations etc.); snow measuring unit settings (snow level thresholds, snow types, temperature and moisture thresholds etc.); and events 7 and reporting settings 8 (alerts and emergencies notifications via text, SMS, email and the like). In some embodiments, computing device 902 may be a handheld device such as a cell phone or tablet. In some embodiments, computing device 902 may be a personal computer such as a desktop computer or a laptop computer.

The robot 102 and/or docking station 302 may have onboard operations that include but are not limited to: pairing the system components 15; event responses 16 (completing snow removal reports, halts, alarms emergencies, and notifications to app etc.); and collecting data 17 from the snow measuring unit 500. The snow measuring unit 500 may have onboard software operations including but not limited to: measuring climatic conditions 18 (snow weight, volume, moisture content etc.) 18; collecting data 19 and transmitting said data to the robot 102 and/or docking station 302. In other embodiments, the app, robot 102, docking station 302, and snow measuring unit 502 may being connected by a cloud-based network or network servers 904 with operations that include but are not limited to: administrative functions 12 (subscription services, payments, demographics etc.); configurations 13 (pairing various smart snow blowers, etc.); storing event recordings 14 (onboard cameras, sensors etc.); data libraries 9 (events and snow collection histories); block chain organization of data 10; and notifications 11 (alarms, text, SMS, email etc.). Although the application is shown in wireless communication with a cloud-based network, in some embodiments, the computing device 902 may communicate directly with the robot 102, docking station 302, and/or snow measuring unit 500 such that additional computing servers or networks are not required as part of the system. In some embodiments, communications with cloud networks may take place over the Internet. In some embodiments, the robot 102, docking station 302, and/or snow measuring unit 500 may include cellular or satellite communication links to communicate directly with cloud-based servers, thereby eliminating the need for a user to have any additional routers or Internet connections for the system to function.

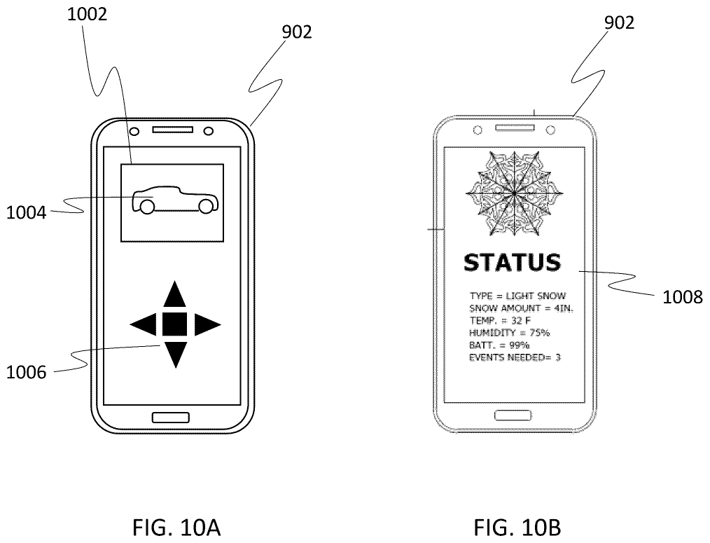

FIG. 10 depicts exemplary displays of an app running on a computing device 902. Referring to FIG. 10A, the app has a first window 1002 that displays a view from a camera on the robot 102. An app interface may include features such as being able to select the view from various cameras. In the present example, window 1002 is displaying an obstacle 1004. In some embodiments, the system may be configured such that the robot 102 may trigger an alert and provide manual controls 1006 to a user to avoid obstacles. For example, manual controls may include directional controls such as forward, reverse, left, right, and stop. In some embodiments, the system may employ an AI that monitors manual control of the app and teaches the robot 102 how to avoid obstacles or maneuver out of similar situations in the future without requiring manual control by a user. For example, the AI may use machine learning to learn avoidance techniques. Machine learning may further be employed to improve other aspects or code on the snow removal system. FIG. 10B depicts exemplary status alerts on an app running on computing device 902. In some embodiments, status alerts may be related to weather conditions. In some embodiments, status alerts may be visual representations. For example, a snowflake may indicate it is currently snowing, whereas in image of the sun may indicate it is sunny outside. In some embodiments, weather alerts may include data such as temperature, humidity, wind speed, or the like. In some embodiments, status alerts may include snow conditions such as snow height, snow type, or the like. In some embodiments, status alerts may include technical data regarding the snow removal system such as battery life, projected time until snow cleared, or system faults such as jammed door on the snow measuring unit.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. To the extent that specific structures, compositions and/or processes are described herein with components, elements, ingredients or other partitions, it is to be understand that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated.

Unless indicated otherwise, references to “embodiment(s)”, “disclosure”, “present disclosure”, “embodiment(s) of the disclosure”, “disclosed embodiment(s)”, and the like contained herein refer to the specification (text, including the claims, and figures) of this patent application that are not admitted prior art.

For purposes of interpreting the claims, it is expressly intended that the provisions of 35 U.S.C. 112(f) are not to be invoked unless the specific terms “means for” or “step for” are recited in the respective claim.

What is claimed is:

1. A robot for autonomous removal of snow comprising:
a controller comprising a microprocessor, a receiver, a transmitter, and a memory;
a pair of axially aligned drive wheels;
a body, the body comprising a housing extending between the drive wheels, the housing having a base plate and a cover, the housing defining a housing cavity containing the controller, a power supply, and a wheel drive motor operatively connected to the controller;
a brush assembly, the brush assembly comprising a brush configured to rotate about a central axis, a brush drive motor operatively connected to the controller, a framework, and a shroud, the brush assembly secured to a forward facing portion of the body;
a plurality of sensors disposed about the body and/or the brush assembly, the plurality of sensors being in communication with the controller; and
a snow measuring unit configured to collect snow and to measure and transmit a plurality of the collected snow characteristics to the controller,
wherein the controller determines from the plurality of snow characteristics a schedule for removing snow from a pre-defined area.

2. The robot of claim 1, wherein the plurality of snow characteristics includes a snow volume and a snow weight.

3. The robot of claim 1, wherein the snow measuring unit comprises a scale mounted to a bottom plate, a rearward wall, a left sidewall, a right sidewall, and a front wall surrounding the bottom plate, the rearward wall, the left and right sidewalls, and the front wall defining a snow collection cavity, the scale being configured to measure a weight of collected snow within the snow collection cavity.

4. The robot of claim 3, wherein the front wall comprises a pivoting door, the left sidewall comprises a left sliding panel, and the right sidewall comprises a right sliding panel, and wherein the bottom plate and left and right sliding panels are configured to slide through the pivoting door, such that the collected snow is discarded outside the snow collection cavity.

5. The robot of claim 1, wherein the snow measuring unit comprises a sensor configured to measure a height of the snow, and wherein the snow measuring unit determines a volume of the snow from a width and a length of the snow collection cavity and the height of the collected snow.

6. The robot of claim 1, wherein a boundary wire connected to the snow removal unit defines a snow removal area.

7. The robot of claim 1, wherein the controller comprises a GPS, and wherein the GPS is configured to generate a geofence defining a snow removal area.

8. The robot of claim 1, wherein the robot is configured to avoid obstacles in a predetermined snow removal path.

9. The robot of claim 8, wherein when the robot fails to avoid an obstacle, the robot sends an alert to a user and the robot is controllable from an app running on a handheld computing device.

10. A robot for autonomous removal of snow comprising:
a pair of track wheels and a chassis mounted therebetween, the chassis comprising a controller, a rechargeable battery, and a first drive assembly in communication with the controller and operably coupled to the pair of track wheels; and
an interchangeable snow removal assembly mounted to a forward portion of the chassis, the interchangeable snow removal assembly having a second drive assembly in communication with the controller.

11. The robot of claim 10, wherein the first drive assembly is configured to drive each of the pair of track wheels independently.

12. The robot of claim 10 wherein the interchangeable snow removal assembly attaches to the chassis at a first fixed mounting point and a second adjustable mounting point.

13. The robot of claim 12, wherein the second adjustable mounting point comprises a cable and a tensioning device, the tensioning device configured to adjust a length of the cable.

14. The robot of claim 10, wherein the interchangeable snow removal assembly comprises a brush having a brush shaft, the brush shaft configured to rotate about a central axis, a brush drive motor operatively connected to the controller, a framework, and a shroud.

15. The robot of claim 14, wherein the brush drive motor is mounted above the shroud and wherein the brush drive motor is configured to rotate a drive shaft, the drive shaft being connected to the brush shaft with a differential gear.

16. A method for autonomous snow removal comprising:
providing the robot of claim 1;
installing the snow removal unit in proximity to an area to be cleared of snow;
determining a snow removal plan;
executing the snow removal plan.

17. The method of claim 16, further comprising:
collecting snow in the snow removal unit;
measuring characteristics of the collected snow;
transmitting the measured characteristics to the controller.

18. The method of claim 17, wherein the measured characteristics include a weight and a volume.

19. The method of claim 16, wherein the area to be cleared of snow is defined by a boundary wire.

20. The method of claim 16, wherein the area to be cleared of snow is a geofenced area.
